(19) United States
(12) Patent Application Publication
(10) Pub. No.: US 2008/0057303 A1
(43) Pub. Date: Mar. 6, 2008

(54) Method for Manufacturing Carbon Fiber Reinforced Carbon Composite Material Suitable for Semiconductor Heat Sink

(75) Inventors: Eiki Tsushima, Shizuoka (JP); Kazuyuki Murakami, Shizuoka (JP); Susumu Katagiri, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignees: MITSUBISHI CORPORATION, Chiyoda-ku (JP); FJ COMPOSITE Materials CO., LTD., Fuji-shi (JP)

(21) Appl. No.: 11/631,106

(22) PCT Filed: Jun. 2, 2005
(86) PCT No.: PCT/JP05/10195

§ 371 Date: Dec. 28, 2006

(30) Foreign Application Priority Data
Jul. 6, 2004 (JP) 2004-199468

(51) Int. Cl. B32B 3/10; B29C 67/00; B32B 9/00; B32B 27/00

(52) U.S. Cl. 428/339; 264/29.2

(57) ABSTRACT

To provide a novel process for producing a unidirectional carbon fiber reinforced carbon composite material having all of high thermal conductivity, low thermal expansion properties and high strength, useful as e.g. a semiconductor heatsink. Carbon fibers are impregnated with a liquid for impregnation prepared by dispersing or dissolving powdery carbon, fine carbon fibers having a fiber diameter of from 0.5 to 500 nm and a fiber length of at most 1,000 μm and having a hollow-structured central axis and a thermosetting resin in a medium, and the carbon fibers are molded, cured and then carbonized so that they are aligned in one direction.

### TECHNICAL FIELD

The present invention relates to a process for producing a unidirectional carbon fiber reinforced carbon composite material (hereinafter sometimes referred to simply as a unidirectional C/C composite material) suitable for a semiconductor heatsink.

### BACKGROUND ART

A carbon fiber reinforced carbon composite material (hereinafter sometimes referred to simply as a C/C composite material) is a light weight material having high thermal conductivity and excellent in heat resistance and thermal shock resistance, and is useful as a heat resistant component such as a heat resistant material for space shuttles or a wall material of nuclear diffusion reactors and a brake material for e.g. aircraft or racing cars which are used under severe conditions, as a heat resistant slide material. Particularly, it attracts attention in recent years as a promising material for a so-called heatsink used in an apparatus on which a semiconductor device is mounted, which effectively releases heat generated from the semiconductor device so as to secure performance and the life of the semiconductor device.

On the other hand, when a conventional C/C composite material is used for such applications particularly for a semiconductor heatsink, the following problems will arise. Namely, although a C/C composite material made of woven fabric of carbon fiber bundles or a C/C composite material made of felt of carbon fibers has high mechanical strength since carbon fibers having a high thermal conductivity are aligned in many directions, but has insufficient thermal conductivity in the heat flow direction between a heat source and a cooling source. Further, a unidirectional C/C composite material having such a structure that carbon fibers are aligned in one direction, has favorable thermal conductivity in the carbon fiber alignment direction, but has small thermal conductivity in a direction at right angles to the carbon fiber alignment direction, since the carbon fibers are not aligned in a direction at right angles to the one direction, and thus it is weak in strength and is less like to be broken. Accordingly, a unidirectional C/C composite material having high strength and a high elastic modulus in a direction at right angles to the fiber alignment direction has been desired.

As the most important method to produce a conventional unidirectional C/C composite material is a method of using a thermosetting resin as the matrix precursor. However, in this method, the carbonization yield of the resin used is so low as about 50%, whereby cracks or voids are likely to occur, and accordingly the strength in a direction at right angles to the carbon fiber alignment direction can not be increased. In this method, a method may also be employed wherein the occurred cracks or voids are impregnated with carbonaceous pitch many times (usually 5 to 10 times) by a method called re-impregnation to reduce the defects, but this method takes much time and further, the strength can not sufficiently be increased even when the defects are reduced.

Further, a method may be mentioned wherein carbonaceous pitch as the matrix precursor is melted and carbonized after impregnation. The carbonaceous pitch used in this method has a low softening point (usually at most 350° C.) to such an extent that impregnation is possible, whereby the carbonization yield is low. As a result, by this method also, cracks or voids occur at the time of carbonizing similar to the above two methods, and the strength in a direction at right angles to the carbon fiber alignment direction can not be increased.

### DISCLOSURE OF THE INVENTION

Object to be Accomplished by the Invention

It is an object of the present invention to provide a process capable of producing a unidirectional C/C composite material having no cracks nor voids, and having a high thermal conductivity and high strength in a direction at right angles to the carbon fiber alignment direction, without requiring re-impregnation or the like in a short time.

Means to Accomplish the Object

The present inventors have conducted extensive studies to accomplish the above object and as a result, found that the object can be accomplished by the invention which provides the following.
(1) A process for producing a unidirectional carbon fiber reinforced carbon composite material, which comprises impregnating carbon fibers with a liquid for impregnation prepared by dispersing or dissolving powdery carbon, fine carbon fibers having a fiber diameter of from 0.5 to 500 nm and a fiber length of at most 1,000 μm and having a hollow-structured central axis and a thermosetting resin in a medium, and molding, curing and then carbonizing the carbon fibers so that they are aligned in one direction.
(2) The process for producing a unidirectional carbon fiber reinforced carbon composite material according to the above (1), wherein the fine carbon fibers are vapor grown carbon fibers.
(3) The process for producing a unidirectional carbon fiber reinforced carbon composite material according to the above (1) or (2), wherein the fine carbon fibers are graphitized in a non-oxidizing atmosphere at from 2,300 to 3,500° C.
(4) The process for producing a unidirectional carbon fiber reinforced carbon composite material according to any one of the above (1) to (3), wherein the fine carbon fibers are fine carbon fibers covered with a phenolic resin, the surface of which is covered with a phenolic resin in an amount of from 1 to 40 parts by weight per 100 parts by weight of the fine carbon fibers.
(5) The process for producing a unidirectional carbon fiber reinforced carbon composite material according to any one of the above (1) to (4), wherein the powdery carbon is a carbon powder containing at least 30 mass % of low-volatile pitch.
(6) The process for producing a unidirectional carbon fiber reinforced carbon composite material according to any one of the above (1) to (5), wherein the thermosetting resin is a phenolic resin and/or a furan resin.
(7) The process for producing a unidirectional carbon fiber reinforced carbon composite material according to any one of the above (1) to (6), wherein the unidirectional carbon fiber reinforced carbon composite material is a semiconductor heatsink.
(8) A unidirectional carbon fiber reinforced carbon composite material, which comprises powdery carbon, fine carbon fibers having a fiber diameter of from 0.5 to 500 nm and a fiber length of at most 1,000 μm and having a hollow-structured central axis, a thermosetting resin and carbon fibers, characterized by having a thermal conductivity of at least 20 W/mK, a coefficient of thermal expansion of at most 15×10⁻⁶/° C., an elastic modulus of at least 10 GPa and a tensile strength of at least 20 MPa, in a direction at right angles to the carbon fiber alignment direction.
(9) The unidirectional carbon fiber reinforced carbon composite material according to the above (8), wherein the unidirectional carbon fiber reinforced carbon composite material is a semiconductor heatsink.

### EFFECTS OF THE INVENTION

According to the present invention, a process capable of producing a unidirectional C/C composite material having no cracks nor voids and having high thermal conductivity and high strength in a direction at right angles to the carbon fiber alignment direction, without requiring re-impregnation or the like in a short time, is provided. A unidirectional C/C composite material produced by the present invention has a thermal conductivity of at least 20 W/mK, a coefficient of thermal expansion of at most 15×10⁻⁶/° C., an elastic modulus of at least 10 GPa and a tensile strength of at least 20 MPa, in a direction at right angles to the carbon fiber alignment direction, is excellent in high thermal conductivity, heat shock resistance, high strength and light weight properties, and is thereby suitable as a so-called heatsink in an apparatus on which s a semiconductor device is mounted.

### BEST MODE FOR CARRYING OUT THE INVENTION

The powdery carbon used for formation of a liquid for impregnation in the present invention may be a carbon powder obtained by subjecting coke, graphite, low-volatile pitch of calcined coke to heat treatment at a temperature higher than their formation temperature. Graphite may be natural graphite from which the ash content is removed, but preferred is an artificial graphite powder obtained by heating coke at a temperature of from 2,500 to 3,000° C. for example. As the size of the carbon powder, the average particle size is preferably at most 30 μm, more preferably from 0.5 to 10 μm.

In the present invention, as the powdery carbon, particularly preferred is one containing at least 30 wt % of low-volatile pitch with low volatile content. If the content of the low-volatile pitch is less than 30 wt %, the formed matrix carbon tends to have low bonding properties and sintering properties and tends to have low denseness, and the quality of the carbon-carbon composite material tends to decrease. From such a viewpoint, the low-volatile pitch is contained in an amount of more preferably at least 50 wt %, furthermore preferably at least 80 wt % in the carbon powder. The low-volatile pitch may be a petroleum type, a coal type or a compound type obtained by subjecting heavy oil or pitch to heat treatment at from 400 to 550° C. for example. The volatile content is from 5 to 20%. If the volatile content is less than 5%, the bonding properties with resinous coal or another carbon powder and the sintering properties tend to be low in the carbonization process, and if it exceeds 20%, the carbonization yield tends to be low, and the quality of the carbon-carbon composite material tends to be low in either case. Therefore, the volatile content is more preferably from 7 to 15%. The low-volatile pitch includes one having self-sintering properties usually called green coke. This may, for example, be one having a volatile content of about 10% produced, for example, by heating petroleum type heavy oil at a temperature of about 500° C. by delayed coking method. The volatile content means the rate of weight reduction when the temperature is increased at a rate of 20° C. per minute up to 100° C. to 1,000° C. in an atmospheric pressure in an inert atmosphere.

The fine carbon fibers used in the present invention are fine carbon fibers having a fiber diameter of from 0.5 to 500 nm and a fiber length of at most 1,000 μm and preferably having an aspect ratio of from 3 to 1,000, preferably having a multilayer structure having cylinders comprising a carbon hexagonal plane concentrically disposed and having a hollow-structured central axis. Such fine carbon fibers are greatly different from conventional carbon fibers having a fiber diameter of s from 5 to 15 μm, obtainable by subjecting conventional fibers such as PAN, pitch, cellulose or rayon to heat treatment. The fine carbon fibers used in the present invention are greatly different from conventional carbon fibers not only in the fiber diameter and the fiber length but also in the structure. As a result, very excellent physical properties such as electrical conductivity, thermal conductivity and sliding properties are achieved.

If the fiber diameter of the fine carbon fibers is smaller than 0.5 nm, the strength of the composite material to be obtained will be insufficient, and if it is larger than 500 nm, mechanical strength, thermal conductivity, sliding properties, etc. will be low. Further, if the fiber length is longer than 1,000 μm, the fine carbon fibers are hardly dispersed uniformly in the carbon matrix, whereby the composition of the material tends to be non-uniform, and the composite material to be obtained tends to have low mechanical strength. The fine carbon fibers used in the present invention are particularly preferably ones having a fiber diameter of from 10 to 200 nm and a fiber length of from 3 to 300 μm, and preferably an aspect ratio of from 3 to 500. In the present invention, the fiber diameter and the fiber length of the fine carbon fibers can be measured by an electron microscope.

Preferred fine carbon fibers used in the present invention are carbon nanotubes. The carbon nanotubes are also called graphite whisker, filamentous carbon, carbon fibrils or the like, and they are classified into single layer carbon nanotubes comprising a single graphite layer forming the tube and multilayer carbon nanotubes comprising a plurality of layers, and both can be used in the present invention. However, multilayer carbon nanotubes are preferred, with which high mechanical strength will be obtained and which are advantageous in economical viewpoint.

Carbon nanotubes are produced by e.g. arc discharge, laser vaporization or heat decomposition, for example, as disclosed in “Fundamentals of Carbon Nanotubes” (published by CORONA PUBLISHING CO., LTD., pages 23 to 57, 1998). The carbon nanotubes are ones having a fiber diameter of preferably from 0.5 to 500 nm, a fiber length of preferably from 1 to 500 μm and preferably an aspect ratio of from 3 to 500.

Particularly preferred fine carbon fibers in the present invention are vapor grown carbon fibers having relatively large fiber diameter and fiber length among the above carbon nanotubes. Such vapor grown carbon fibers are also called VGCF, and produced by vapor phase heat decomposition of a gas of e.g. a hydrocarbon together with a hydrogen gas in the presence of an organic transition metal type catalyst, as disclosed in JP-A-2003-176327. The vapor grown carbon fibers (VGCF) have a fiber diameter of preferably from 50 to 300 nm, a fiber length of preferably from 3 to 300 μm, and preferably have an aspect ratio of from 3 to 500. The VGCF are excellent in view of productivity and handling efficiency.

The fine carbon fibers used in the present invention are preferably subjected to heat treatment at a temperature of at least 2,300° C., preferably from 2,500 to 3,500° C. in a non-oxidizing atmosphere, whereby the surface will be graphitized, and the mechanical strength and the chemical stability will greatly improve, and the composite material to be obtained will be light in weight. As the non-oxidizing atmosphere, an argon, helium or nitrogen gas is preferably used.

In the present invention, the fine carbon fibers may be used as they are, but use of fine carbon fibers, the surface of which is covered with a phenolic resin, is preferred. When such fine carbon fibers covered with a resin are used, the dispersed state will be uniform, and a unidirectional C/C composite material having excellent characteristics will be obtained. The amount of the phenolic resin with which the surface of the fine carbon fibers is covered is preferably from 1 to 40 parts by weight, particularly preferably from 5 to 25 parts by weight per 100 parts by weight of the fine carbon fibers. The fine carbon fibers covered with a phenolic resin can be produced by reacting a phenol and an aldehyde while they are mixed with the fine carbon fibers in the presence of a catalyst.

In the present invention, the thermosetting resin may be selected from a wind range of resins, but preferred is a thermosetting resin with high carbonization yield, and particularly preferred is a phenolic resin, a furan resin or a mixture thereof. The phenolic resin may be classified into a resole type obtainable by reaction of a phenol with an aldehyde in the presence of an alkali and a novolak type obtainable from a phenol and an aldehyde by means of an acidic catalyst, and may be classified into a liquid one and a solid one at room temperature. The novolak type is preferably a self-curing type containing a curing agent such as hexamethylenediamine. Further, various phenolic resins may be mixed.

Further, as the furan resin, a furan resin precondensate may be used.

The precondensate includes one comprising furfuryl alcohol or a furfuryl alcohol/furfural mixture. Further, a mixture of a phenolic resin precondensate or a resin before curing with a furan resin precondensate may also be used. The precondensate means a liquid resin.

The liquid for impregnation containing the powdery carbon, the fine carbon fibers and the thermosetting resin may be either in a state where all the components are dispersed in a medium, or in a state where some of them, particularly the thermosetting resin is dissolved in a medium. The medium may be either an aqueous medium or an organic medium, but in the case of a liquid for impregnation having the thermosetting resin dissolved in a medium, an organic solvent in which the thermosetting resin is dissolved is used. Such an organic solvent may, for example, be an alcohol such as ethanol or butanol, a polar solvent such as acetone or THF, furfural or furfuryl alcohol or a mixture thereof. By use of such an organic solvent, for example, many of phenolic resins which are solid at room temperature are softened at a temperature of from 60 to 95° C. which is lower than the curing temperature, whereby the carbon fibers can be held in a time required to sufficiently dry the organic solvent in the above temperature range while curing reaction will not substantially proceed and no voids will occur. Such an organic solvent also has such advantages that vacuum heating or drying by heating under vacuum will more easily be carried out in view of the drying rate.

In the preparation of the liquid for impregnation, the order of addition and mixing of the powdery carbon, the fine carbon fibers and the thermosetting resin is not particularly limited. However, in a case where an organic solvent in which the thermosetting resin is dissolved is used, first, the thermosetting resin is dissolved in the organic solvent, and then the powdery carbon and the fine carbon fibers are dispersed in the obtained resin solution. As a method of dispersing such materials in the medium, an optional method such as a method of using a ball mill or a method of using ultrasonic waves may be employed. The ratio of content of the powdery carbon, the fine carbon fibers and the thermosetting resin in the liquid for impregnation varies depending upon e.g. the type and physical properties of the respective materials, but usually, where the total amount of the thermosetting resin, the powdery carbon and the fine carbon fibers is 100 parts by weight, the thermosetting resin is preferably from 10 to 50 parts by weight (preferably from 15 to 30 parts by weight), the powdery carbon is from 5 to 80 parts by weight (preferably from 10 to 70 parts by weight) and the fine carbon fibers are preferably from 5 to 50 parts by weight (preferably from 10 to 45 parts by weight). By such a ratio, the liquid for impregnation is usually in a slurry state, but it is adjusted so as not to have an excessively high viscosity so that the carbon fibers can be impregnated.

In the present invention, the carbon fibers to be impregnated with the above liquid for impregnation may be any of PAN type, pitch type and other carbon fibers, but ones having a diameter of preferably from 5 to 20 μm, particularly preferably from 7 to 15 μm are suitable. Particularly, high quality meso phase pitch type carbon fibers having a high thermal conductivity are preferred. Needless to say, graphite fibers obtained by carbonizing at a higher temperature may also be employed. Impregnation of the carbon fibers with the liquid for impregnation is carried out usually at room temperature, but may be carried out with heating within a temperature range in which the curing reaction of the resin will not substantially proceed. The means for the impregnation may be one depending upon the shape of the carbon fibers. For example, in the case of continuous fibers, the fibers may be impregnated by continuously dipping them in the liquid for impregnation and then wound onto a drum or a frame. The impregnation may be carried out also under reduced pressure.

After the impregnation with the liquid for impregnation, the carbon fibers prior to molding are put together in one election and cut into a sheet and then dried. Drying is carried out usually with heating, but may be carried out under reduced pressure to shorten the drying time. The drying is carried out preferably within a range of from a temperature at which the resin is softened to a temperature at which the curing reaction of the resin does not substantially proceed. The temperature is, for example, within a range of from 50 to 100° C. At the time of molding, the remaining solvent can be sufficiently removed by reducing the pressure at the initial stage of the molding step at a temperature of from 60 to 90° C. or a temperature in the vicinity thereof.

The content of the carbon fibers in the obtained matrix precursor-containing carbon fibers, i.e. the volume fraction (Vf) of the carbon fibers is suitably from 40 to 80%, particularly preferably from 50 to 75% after carbonizing. If the carbon fiber volume fraction is less than 40%, the thermal conductivity of the obtained unidirectional C/C composite material in the carbon fiber alignment direction tends to be low, and the coefficient of thermal expansion in a direction at right angles to the carbon fiber alignment direction tends to be high. On the other hand, if the carbon fiber volume fraction exceeds 80%, the amount of the matrix tends to be insufficient, and the bending strength in the above direction tends to be small, and the unidirectional C/C composite material can not substantially be prepared.

Sheets of the dried sheet-shaped matrix precursor-containing carbon fibers are laminated so that the carbon fibers are aligned in one direction and then molded usually under an elevated pressure of from 5 to 25 MPa. Molding is conducted utilizing the curing reaction of the resin. The molding temperature range is from 80 to 200° C. for example in the case of a phenolic resin, from 70 to 160° C. for example in the case of a furan resin, and from 70 to 200° C. for example in the case of a mixture thereof. However, the temperature is not limited to this range. The heating time is usually from 10 minutes to 10 hours or longer. It is preferred to gradually raise the temperature stepwise or continuously within this temperature range. Pressurization is conducted usually within a range of from 5 to 25 MPa, particularly preferably from 10 to 20 MPa. The obtained molded product is carbonized in accordance with a known method in an inert atmosphere under an atmospheric pressure or under elevated pressure at a temperature of at least 2,000° C., preferably at a temperature of at least 2,500° C., and as the case requires, further graphitized.

In a conventional method, the impregnation of the resin and the carbonizing treatment have to be repeatedly carried out so as to densify the C/C composite material and improve the strength, but according to the process of the present invention, a dense (specific gravity of at least 1.6) and high strength C/C composite material can be obtained by only one impregnation, molding and carbonizing (graphitization) treatment, and in addition, it is possible to shorten the carbonizing time. Accordingly, a production time of from 3 to 6 months has been required for impregnation and carbonizing comprising repetition of heating and cooling which require about one week each 5 to 10 times, but according to the process of the present invention, production is possible in one day.

The unidirectional C/C composite material obtained by the present invention has such characteristics as high thermal conductivity, a low coefficient of thermal expansion and high strength in a direction at right angles (90°) to the axis of alignment of the carbon fibers. Specifically, it has such characteristics as a thermal conductivity of at least 20 W/mK, particularly at least 30 W/mK, a coefficient of thermal expansion of at most 15×10⁻⁶/° C., particularly at most 12×10⁻⁶/° C., an elastic modulus of at least 10 GPa, particularly at least 15 GPa and a tensile strength of at least 20 MPa, particularly at least 25 MPa, in a direction at right angles to the carbon fiber alignment direction. In the present invention, the thermal conductivity is determined by a laser flash method, the coefficient of thermal expansion by a method in accordance with JIS C2141, and the elastic modulus and the tensile strength by a method in accordance with JIS R-1601, respectively.

Now, the present invention will be described in further detail with reference to Examples, but the present invention is by no means restricted thereto. In the following, parts are based on the weight in all cases.

### EXAMPLES

### Examples 1

As powdery carbon, one having an average particle size of 1.3 μm and having such a particle size distribution that the amount of particles of at most 1 μm was 41 wt %, the amount of particles of from 1 to 2 μm was 28 wt % and the amount of particles of at least 2 μm of 31 wt %, was used. As fine carbon fibers, fine carbon fibers covered with a phenolic resin prepared as follows were used. 20 Parts by weight of bisphenol A (solubility in water at room temperature: 0.036), 365 parts by weight of phenol, 547 parts by weight of 37 wt % formalin and 7.7 parts by weight of triethylamine were charged in a reaction container. Then, 1,835 parts by weight of fine carbon fibers graphitized by subjecting vapor grown carbon fibers having a fiber diameter of 150 nm, a fiber length of 15 μm and an aspect ratio of 100 in an argon gas atmosphere at a temperature of 2,800° C. for 30 minutes, and 1,500 parts by weight of water were charged (amount of hydrophobic bisphenol A: 5 wt % of phenols). The temperature was raised to 90° C. over a period of 60 minutes while the mixture was stirred, and reaction was carried out as it was for 4 hours. Then, after cooling to 20° C., the content in the reaction container was collected by filtration using a Buchner funnel to obtain fine carbon fibers covered with a phenolic resin having a water content of 22 wt %. The fibers were dried in a circulating hot air dryer at a temperature in the dryer of 45° C. for about 48 hours to obtain fine carbon fibers covered with a phenolic resin having a phenolic resin content of 15 wt %.

Further, as a thermosetting resin, 20 parts of a phenolic resin (tradename: LA-100P, manufactured by Lignyte Co., Ltd.) was dissolved in 200 parts of ethanol, and 0.4 kg of the above powdery carbon and 0.3 kg of the fine carbon fibers were kneaded with 1 kg of the solution, and 150 parts of ethanol was further added to adjust the viscosity to 50 poise. In this solution for impregnation, continuous fibers of meso phase pitch type high-modulus carbon fibers (diameter: 10 μm) were immersed, pulled up and put together in one direction, air dried for 12 hours and then dried by heating at 65° C. for 1 hour under a reduced pressure of about 10⁻¹ Torr to prepare a prepreg sheet.

96 Such obtained prepreg sheets were laminated in a mold in one direction, followed by press curing at 150° C. (20 MPa) to obtain a plate-shaped molded product with a size of 100 mm×100 mm×20 mm in thickness. The molded product was carbonized by heating under ordinary pressure in an argon atmosphere up to 3,200° C. (1° C./min (up to 1,000° C.), 5° C./min (1,000 to 3,200° C.)) to obtain a unidirectional C/C composite material having a carbon fiber volume fraction (Vf) of about 60%.

With respect to the obtained plate-shaped molded product, the thermal conductivity (W/mK), the coefficient of thermal expansion (×10⁻⁶/° C.), the elastic modulus (GPa) and the tensile strength (MPa) in a carbon fiber alignment direction and in a direction at right angles to the alignment of the carbon fibers, were measured. The results are shown in Table 1.

### Example 2

A plate-shaped molded product having the same dimensions was obtained in the same manner as in Example 1 except that the carbonizing temperature was changed from 3,000° C. to 2,500° C., and of the plate-shaped molded product, the thermal conductivity, the coefficient of thermal expansion, the elastic modulus and the tensile strength in a carbon fiber alignment direction and in a direction at right angles to the alignment of the carbon fibers, were measured. The results are shown in Table 1.

TABLE 1

| | Fine | | | | |
|---|---|---|---|---|---|
| | carbon | Example 1 | | Example 2 | |
| | fiber | | Direction | | Direction |
| | content | Alignment | at right | Alignment | at right |
| | (%) | direction | angles | direction | angles |
| Thermal | 0 | 8 | 450 | 8 | 350 |
| conductivity | 10 | 40 | 480 | 40 | 380 |
| | 20 | 75 | 520 | 75 | 420 |
| Coefficient | 0 | 6 | 0 | 10 | 0 |
| of thermal | 10 | 5.4 | 0 | 9 | 0 |
| expansion | 20 | 4.8 | 0 | 8 | 0 |
| Elastic | 0 | 7 | 450 | 7 | 320 |
| modulus | 10 | 35 | 480 | 35 | 380 |
| | 20 | 60 | 500 | 60 | 400 |
| Tensile | 0 | 10 | 900 | 20 | 900 |
| strength | 10 | 80 | 970 | 85 | 970 |
| | 20 | 140 | 1030 | 150 | 1030 |

1. A process for producing a unidirectional carbon fiber reinforced carbon composite material, which comprises impregnating carbon fibers with a liquid for impregnation prepared by dispersing or dissolving powdery carbon, fine carbon fibers having a fiber diameter of from 0.5 to 500 nm and a fiber length of at most 1,000 μm and having a hollow-structured central axis and a thermosetting resin in a medium, and molding, curing and then carbonizing the carbon fibers so that they are aligned in one direction.

2. The process for producing a unidirectional carbon fiber reinforced carbon composite material according to claim 1, wherein the fine carbon fibers are vapor grown carbon fibers.

3. The process for producing a unidirectional carbon fiber reinforced carbon composite material according to claim 1 or 2, wherein the fine carbon fibers are graphitized in a non-oxidizing atmosphere at from 2,300 to 3,500° C.

4. The process for producing a unidirectional carbon fiber reinforced carbon composite material according to any one of claims 1 to 3, wherein the fine carbon fibers are fine carbon fibers covered with a phenolic resin, the surface of which is covered with a phenolic resin in an amount of from 1 to 40 parts by weight per 100 parts by weight of the fine carbon fibers.

5. The process for producing a unidirectional carbon fiber reinforced carbon composite material according to any one of claims 1 to 4, wherein the powdery carbon is a carbon powder containing at least 30 mass % of low-volatile pitch.

6. The process for producing a unidirectional carbon fiber reinforced carbon composite material according to any one of claims 1 to 5, wherein the thermosetting resin is a phenolic resin and/or a furan resin.

7. The process for producing a unidirectional carbon fiber reinforced carbon composite material according to any one of claims 1 to 6, wherein the unidirectional carbon fiber reinforced carbon composite material is a semiconductor heatsink.

8. A unidirectional carbon fiber reinforced carbon composite material, which comprises powdery carbon, fine carbon fibers having a fiber diameter of from 0.5 to 500 nm and a fiber length of at most 1,000 μm and having a hollow-structured central axis, a thermosetting resin and carbon fibers, characterized by having a thermal conductivity of at least 20 W/mK, a coefficient of thermal expansion of at most 15×10⁻⁶/° C., an elastic modulus of at least 10 GPa and a tensile strength of at least 20 MPa, in a direction at right angles to the carbon fiber alignment direction.

9. The unidirectional carbon fiber reinforced carbon composite material according to claim 8, wherein the unidirectional carbon fiber reinforced carbon composite material is a semiconductor heatsink.
